(19) United States
(12) Patent Application Publication
(10) Pub. No.: US 2003/0068454 A1
(43) Pub. Date: Apr. 10, 2003

(54) Packaged pre-moistened wipes and method for cleaning breasts during nursing regimen

(76) Inventor: Carolyn J. Smith, North Charleston, SC (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/303,877

(22) Filed: Nov. 26, 2002

Related U.S. Application Data
(63) Continuation-in-part of application No. 09/848,517, filed on May 4, 2001.

(51) Int. Cl. B32B 1/02

(52) U.S. Cl. 428/35.2

(57) ABSTRACT

Pre-moistened wipes are hermetically packaged with purified water and used to clean the breasts during a nursing regimen. The wipes are used to practice a method of cleaning the breasts wherein a nursing mother is spared the inconvenience and discomfort of finding tap water to clean her breast after nursing her child.

### RELATED APPLICATIONS

This application is a continuation-in-part of U.S. patent application Ser. No. 09/848,517, filed May 4, 2001.

### FIELD OF THE INVENTION

The present invention is directed to packaged pre-moistened wipes. More particularly, the present invention is directed wipes packaged in purified water and having a specific utility as breast wipes and wipes for articles which may be used by infants and toddlers. Moreover, the present invention is directed to a method of using pre-moistened wipes to clean the breast during a nursing regimen.

### BACKGROUND OF THE INVENTION

In most cases, it is preferable to breast feed babies for a substantial length of time as soon as a mother begins to lactate. It is suggested that mothers periodically clean their breasts by wiping with paper towels or washcloths which have been wet with tap water. It is not suggested that currently available packaged, disposable wipe be used for this purpose. This is because the wipes are frequently soaked with antiseptic compositions which include alcohol as well as oils, perfumes and a large variety of organic chemicals that may well have a bad taste and which could be harmful if ingested even in trace amounts by a child. This is why wiping the breasts and a babies mouth with a moist paper towel or moist washcloth is a preferable way to maintain cleanliness. If the mother is away from a faucet or is for example shopping, in a park or at numerous locations where obtaining and wetting a paper towel is not a viable option. Paper towels or washcloths are not always easy or convenient to obtain. In such situations, a mother frequently tucks her wet breasts back in her clothes where moisture and warmth can encourage bacterial growth and perhaps activate traces of contaminates such as dye or laundry products in her clothes. There are other situations where wetting a washcloth or towel under a faucet is not satisfactory. For example, if a new mother has delivered by caesarian section, getting out of bed to wet a paper towel or washcloth in order to wash her breasts can be a very uncomfortable undertaking.

The prior art simply does not address these issues. Accordingly, there is a need for a product which does address these issues.

### SUMMARY OF THE INVENTION

In view of the aforementioned considerations, the present invention is directed to an arrangement for cleaning a mother's breasts during a nursing regimen comprising at least one disposable wipe made of a non-woven fabric that is sealed in an openable package with purified water, whereby upon opening the package and removing the wipe, the wipe is available to clean the breast with purified water.

In a further aspect of the invention the package contains a plurality of disposable wipes, and a still further aspect the package is flexible and disposable after removing the plurality of wipes.

In a more specific aspect of the invention, the package includes three wipes, each of sufficient area to wipe a portion of the breast, all three wipes being usable for a single cleaning of the breasts.

In additional aspects, there are a plurality of packages containing disposable wipes, packaged together in a single packaging unit for multiple cleanings of the breasts over a selected period of time.

In still further aspect of the invention, the purified water is distilled water or is irradiated water which has been sanitized by gamma radiation after the towelettes have been sealed within the packages with water.

In further aspects of the invention, the packaged wipes are autoclaved for sterilization, or the wipes and package are steam sterilized prior to assembly.

The invention is also directed to a method of maintaining breast cleanliness during a nursing regimen comprising keeping disposable hermetic packages of pre-moistened wipes moistened with purified water is proximately with a nursing mother. After each breast feeding, at least one package is opened, a breast is cleaned with the wipes and thereafter discarded.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view of a package of individual pre-moistened breast wipes;

FIG. 2 is a top view of a single individual breast wipe contained within the package of FIG. 1;

FIG. 3 is an elevational view taken along line 3-3 of FIG. 1;

FIG. 4 is a top view of a dispenser for plurality of packaged, pre-moistened breast wipes, and

FIG. 5 is a top view of a dispenser for a relatively large number of breast wipes having relatively large size.

### DETAILED DESCRIPTION

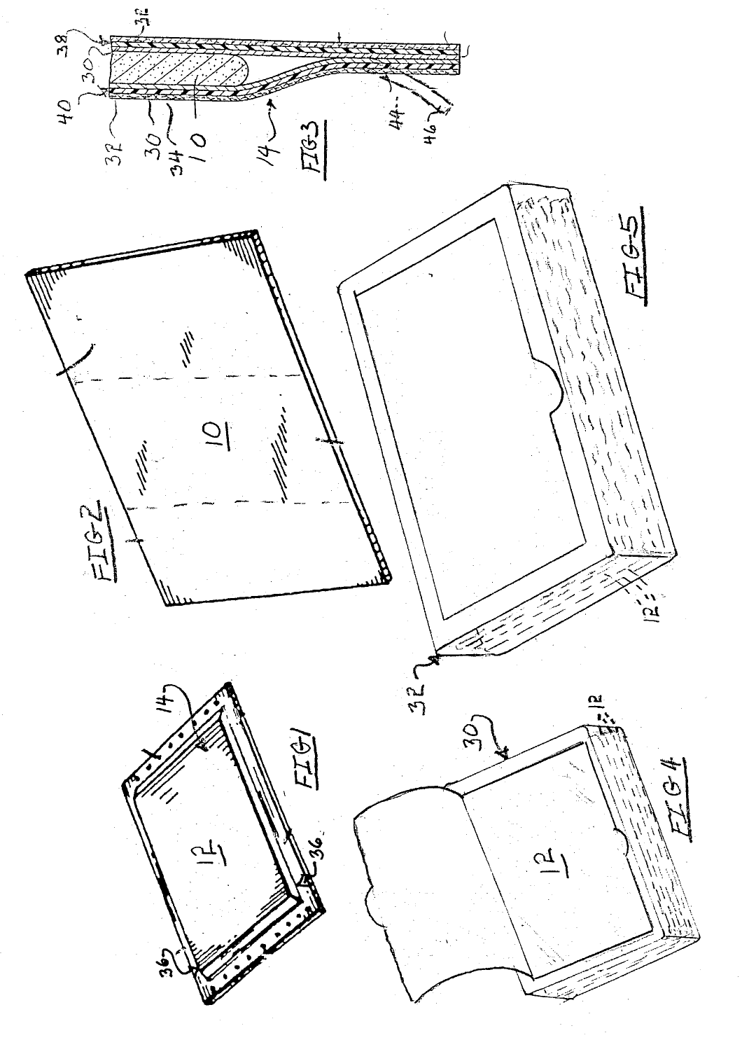

Referring now to FIGS. 1 and 2, individual breast wipes 10 are folded to fit into breast wipe packages 12, wherein a single breast wipe 10 is disposed in a single hermetic envelope 14. Alternatively two or more folded breast wipes 10 are contained in a single hermetic envelope 14. Three breast wipes 10 may be an optimum number in a single package. Each package 12 is preferably of a size conveniently carried in a baby bag with other baby accessories, in a pocket or in a pocket book. The individual packages are preferably of a size of about 2 inches by 2¼ inches while the individual breast wipes are about 5 inches by 5½ inches and are folded within the package 12. Preferably, one package 12 is opened for a single cleaning using all of the breast wipes in the package.

As is seen in FIGS. 4 and 5, a plurality of the breast wipe packages 12 may be packaged in single dispenser. For example, in FIG. 4 a small dispenser 30 is utilized wherein twenty-five breast wipe packages 12 are contained therein, and in FIG. 5 a larger dispenser 32 is shown wherein sixty breast wipe packages 12 are contained therein. In the small dispenser 30 the individual breast wipes 10 might have a size of 6 inches by 4 inches and with the large dispenser 32 the breast wipes might have a size of 10 inches by 7 inches. Typically, the smallest dispenser will have a height of 1 inch and the large dispenser might have a height of 1½ inches.

Exemplary of breast wipes 10 of the present invention are wipes comprised of a substrate comprising a non-woven web of natural fibers, synthetic fibers, or mixtures of natural and synthetic fibers. Suitable natural fibers include, but are not limited to, cellulose fibers, such as wood pulp fibers commonly used in textiles, including but not limited to polyolefins, such as polyester and polypropylene fibers. In a preferred embodiment viscose (rayon) may be used in combination with polypropylene for an economical balance of softness and bondability. The viscose provides excellent softness and cloth-like properties, but used alone tends to produce a flannel-like web, which is not currently preferred by consumers of baby wipes. Polypropylene when used alone produces a web that is too slick and synthetic-feeling for consumers of baby wipes. Blending the two types of fibers changes the flannel-like feel of the viscose fibers into a more silky-feel, which gives the wipes a silky-soft feel, which is consumer approved for baby wipes.

Non-woven sterilized wipes are economical and of consistent quality. The non-woven materials can be made from a variety of processes including, but not limited to, air laying processes, wet laid processes, hydro-entangling processes, spunbonding, meltblowing, staple fiber carding and bonding, and solution spinning. The fibers themselves can be made from a variety of both natural and synthetic materials including, but not limited to, cellulose, RAYON®, polyesters, polyolefins and many other thermoplastic materials. The fibers may be relatively short, staple length fibers, typically less than 3 inches, or longer more continuous fibers such as are produced by spunbonding and meltblowing processes. Whatever materials are chosen, the resultant wipe must be compatible with the particular sterilization technique being used.

While the above described configuration for a breast wipes 10 are preferred exemplary, it is to be kept in mind that the breast wipes can be constructed of any suitable materials included but not limited to RAYON®, cotton, DACRON®, and the like.

While using only distilled water as the purified water is strongly preferred, each package 12 may contain a small effective amount of a safe water soluble lotion, such as baby-type aloe vera lotion, may, be added to the wipes. In a package of a plurality of wipes 10, one or more than one wipe may have the lotion and at least one wipe may be free of lotion.

As is seen in FIG. 3, one embodiment of a hermetic envelope 14 comprises a layer of aluminum foil 30 surrounding the breast wipe 10 and a layer 32 of polyethylene which is laminated to the aluminum foil. Covering the layer 32 of polyethylene is a layer of paper 34 on which a pleasing design or written indicia is placed. While the package of FIG. 3 is a preferable packaging arrangement, other arrangements may be employed. It is only necessary that the breast wipe package 12 be hermetically sealed so that water can not leak therefrom and so that the surrounding atmosphere can not enter the package and contaminate the purified water therein. In the illustrated embodiment, the aluminum layers may be sealed together by an adhesive (such as acrylic adhesive) or by continuous welds. In order to open the package 12, one or more notches 36 are provided in the package adjacent the end of the package so that the package may be torn open in order to extract the breast wipe or breast wipes 10 therefrom. In another approach only back wall 38 has the aluminum foil layer 30 while the front wall 40 is made of polyethylene and is heat welded to the aluminum foil layer of the back wall. The front wall 40 has a portion 44 which is not welded and is therefore free, forming a tab 46 which can be pulled up to open the package for access to the breast wipe moistened with purified water.

The packages 12 may also be made in the same manner that other packages, currently available, that contain other types of pre-moistened wipes are made.

Prior to packaging the breast wipes 10, the wipes are preferably presaturated with clean filtered water, which in accordance with one embodiment of the invention, is also distilled in order to enhance its purity. In order for the water to remain pure after packaging during the shelf life of the packaged wipes, it is necessary to sterilize the breast wipes 10 themselves and to sterilize at least the inside of the hermetic envelope 14. One approach is to autoclave the packages 12 after the packages are sealed. The autoclaving applies a temperature which is sufficient to kill bacteria and viruses which may be in the packaged water, in or on the breast wipes 10 themselves, or on the interior surfaces of the hermetic envelope 14. Pressure within the autoclave is elevated to a level sufficient to keep the water from boiling, while the temperature, though high enough to kill infectious agents, is not high enough to destroy or substantially degrade either the breast wipes 10 or packaging envelope 14.

In another approach, the breast wipes 10 are sterilized in an enclosed steam treatment facility by application of steam to the breast wipes 10 and to at least the interior surfaces of the hermetic envelope 14. Upon allowing the steam to condense on the wipes 10 by cooling the treatment facility, the wipes 10 become pre-moistened with distilled water. If additional water is needed the wipes 10 are soaked with purified water which may be distilled water. The pre-moistened wipes 10 are then inserted in hermetic packaging envelopes 14 and the packaging envelopes are sealed. Insertion of the breast wipes 10 soaked with purified water into the packaging envelopes 14, and sealing the packaging envelopes, occurs in a sterile environment. Technology for sterilizing unwoven materials with steam is disclosed in U.S. Pat. No. 5,635,134, filed Jun. 6, 1995 and incorporated herein in its entirety by reference.

Another approach to sterilizing pre-moistened breast wipes 10 sealed within hermetic envelopes 14 is to apply gamma radiation to the sealed breast wipe packages 12. Gamma radiation prevents microbial growth inside the sealed packages 12 that keeps the purified water sterile over an extended period of time. The gamma-radiation can be applied at levels from about 0.05 to 2.0 megarads (mR). Preferably, the amount of gamma radiation is less than about 1.0 mR.

What I claim is:

1. An arrangement for cleaning breasts and a baby's mouth areas during a woman's nursing regimen, comprising:
at least one disposable wipe made of non-woven fabric;
a sealed but openable package containing the at least one wipe;
purified water within the sealed ruptured package and soaking the at least one disposable wipe, whereby upon opening the package and removing the wipe, the wipe is available to clean the breast.

2. The arrangement of claim 1 wherein the package contains a plurality of disposable wipes.

3. The arrangement of claim 2 wherein the package is flexible and disposable after removing the plurality of wipes.

4. The arrangement of claim 3 wherein the package includes three wipes, each of sufficient area to wipe a portion of the breast all three wipes being usable for a single cleaning of the breast.

5. The arrangement of claim 4 wherein there are a plurality of hermetically sealed packages containing disposable wipes, this packages being packaged together in a single packaging unit for multiple cleanings over a period of time.

6. The arrangement of claim 5 wherein the purified water is distilled water.

7. The arrangement of claim 5 wherein the purified water is irradiated water which has been sanitized by gamma radiation after the wipes have been sealed within the packages with the water.

8. The arrangement of claim 1 wherein the purified water is distilled water.

9. The arrangement of claim 2 wherein the purified water is distilled water.

10. The arrangement of claim 3 wherein the purified water is distilled water.

11. The arrangement of claim 4 wherein the purified water is distilled water.

12. The arrangement of claim 1 wherein the purified water is irradiated water which has been sanitized by gamma radiation after the wipe has been sealed within the packages with the water.

13. The arrangement of claim 2 wherein the purified water is irradiated water which has been sanitized by gamma radiation after the wipes have been sealed within the packages with the water.

14. The arrangement of claim 3 wherein the purified water is irradiated water which has been sanitized by gamma radiation after the wipes have been sealed within the packages with the water.

15. The arrangement of claim 4 wherein the water is irradiated water which has been sanitized by gamma radiation after the wipes have been sealed within the packages with the water.

16. A method of maintaining breast cleanliness during a nursing regimen, comprising:
keeping disposable hermetic packages of non-woven wipes pre-moistened with purified water in proximity with a nursing mother;
after each breast feeding, opening at least one package and removing at least one of said wipes pre-moistened with purified water therefrom;
cleaning at least one breast with said wipe pre-moistened with purified water, and thereafter discarding the wipe.

17. The method of claim 16 wherein each hermetic package contains a plurality of pre-moistened wipes.

18. The method of claim 17 wherein there are a plurality of hermetic packages contained in a single container.
